(19) United States
(12) Patent Application Publication
(10) Pub. No.: US 2023/0244003 A1
(43) Pub. Date: Aug. 3, 2023

(54) PLASTIC OPTICAL PRODUCT AND PLASTIC SPECTACLE LENS

(71) Applicant: TOKAI OPTICAL CO. LTD., Okazaki-Shi (JP)

(72) Inventor: Hirotoshi TAKAHASHI, Okazaki-Shi (JP)

(73) Assignee: TOKAI OPTICAL CO., LTD., Okazaki-Shi (JP)

(21) Appl. No.: 18/299,144

(22) Filed: Apr. 12, 2023

Related U.S. Application Data
(63) Continuation of application No. PCT/JP2021/037054, filed on Oct. 6, 2021.

(30) Foreign Application Priority Data
Oct. 23, 2020 (JP) 2020-178342

(51) Int. Cl. G02B 1/115; G02B 1/14; G02C 7/10

(52) U.S. Cl. CPC G02B 1/115; G02B 1/14; G02C 7/10

(57) ABSTRACT

A plastic optical product 1 includes optical multilayer films 6 formed via intermediate films 4 on both surfaces of a plastic base 2. In each optical multilayer film 6, SiO₂ layers 10 made of SiO₂ and ZrO₂ layers 12 made of ZrO₂ alternate such that a total number of the SiO₂ layers 10 and the ZrO₂ layers 12 is seven and a layer closest to the base 2 is the SiO₂ layer. The SiO₂ layer 10 disposed at a third layer L3 counting from the base 2 has a physical film thickness of not less than 210 nm and not greater than 270 nm. The ZrO₂ layer 12 disposed at a second layer L2 counting from the base 2 has a physical film thickness of not less than 7 nm and not greater than 12 nm.

### CROSS REFERENCE TO RELATED APPLICATION

This application is a Continuation of International Application No. PCT/JP2021/037054, filed on Oct. 6, 2021, which claims the benefit of Japanese Patent Application Number 2020-178342 filed on Oct. 23, 2020, the disclosures of which are incorporated by reference herein in their entireties.

### FIELD OF THE INVENTION

The present invention relates to a plastic optical product that is an optical product having a plastic base, and a plastic spectacle lens.

### BACKGROUND OF THE INVENTION

A lens disclosed in Japanese Patent No. 5211289 has been known as a plastic lens, for a visible range, which is a plastic optical product.

In this lens, an optical multilayer film as an antireflection film is formed on a surface of a base. The optical multilayer film is formed by stacking seven or more layers in total such that low refractive index layers and high refractive index layers alternate. Also, the optical multilayer film is formed so as to exhibit a W-shaped spectral distribution of reflectance with a local maximum point of the center peak around a wavelength of 520 nm, from the viewpoint of assuring processing stability and generally acceptable outer appearance. In a case where a plastic lens having such an antireflection film formed therein is viewed from an incident side, pale-green reflected light is observed.

At the plastic lens, the reflected light is green.

Green is the brightest color among colors perceived with a human eye. In other words, green is located near the local maximum point, when the wavelength is 555 nm, of a spectral luminous efficiency curve representing a ratio of an intensity with which a human eye perceives brightness for each wavelength of light, relative to the maximum sensitivity.

Accordingly, the reflected light from the plastic lens is conspicuous due to its green color although the reflectance is very low and the green is pale-green. In other words, the luminous reflectance at the plastic lens is relatively high in a case where the relative luminous efficiency is taken into consideration.

Particularly, in a case where the plastic lens is used as a spectacle lens, reflected light from a wearer is relatively conspicuous to another person.

A main object of the present invention is to provide a plastic optical product and a plastic spectacle lens that allow reflected light to be more inconspicuous.

### SUMMARY OF THE INVENTION

In order to attain the aforementioned object, the invention as in a first aspect is directed to a plastic optical product including an optical multilayer film formed directly or via an intermediate film on at least one surface of a plastic base. In the optical multilayer film, SiO₂ layers made of SiO₂ and ZrO₂ layers made of ZrO₂ alternate such that a total number of the SiO₂ layers and the ZrO₂ layers is seven and a layer closest to the base is the SiO₂ layer. The SiO₂ layer disposed at a third layer counting from the base has a physical film thickness of not less than 210 nm and not greater than 270 nm. The ZrO₂ layer disposed at a second layer counting from the base has a physical film thickness of not less than 7 nm and not greater than 12 nm.

According to the invention as in a second aspect, in the above-described invention, the ZrO₂ layer disposed at a fourth layer counting from the base has a physical film thickness of not less than 22 nm and not greater than 41 nm.

According to the invention as in a third aspect, in the above-described invention, the SiO₂ layer that is a layer closest to the base has a physical film thickness of not less than 20 nm and not greater than 50 nm.

According to the invention as in a fourth aspect, in the above-described invention, a sum of a physical film thickness of the SiO₂ layer disposed at a fifth layer counting from the base and a physical film thickness of the ZrO₂ layer disposed at a sixth layer counting from the base is not less than 74 nm and not greater than 80 nm.

According to the invention as in a fifth aspect, in the above-described invention, the intermediate film is a hard coating film.

According to the invention as in a sixth aspect, in the above-described invention, luminous reflectance at a surface at which the optical multilayer film is formed is not greater than 0.8%.

According to the invention as in a seventh aspect, in the above-described invention, reflected light at a surface at which the optical multilayer film is formed has a white color or a bluish white color.

In order to attain the aforementioned object, the invention as in an eighth aspect is directed to a plastic spectacle lens including the plastic optical product according to the above-described invention.

A main effect of the present invention is to provide a plastic optical product and a plastic spectacle lens that allow reflected light to be more inconspicuous.

### BRIEF DESCRIPTION OF THE DRAWINGS

FIG. 1 is a schematic cross-sectional view of a plastic optical product according to the present invention.

FIG. 2 shows a graph representing a spectral reflectance distribution in a visible range and an adjacent range, in Examples 1 to 4.

FIG. 3 shows a graph representing a spectral reflectance distribution in a visible range and an adjacent range, in Examples 5 to 7.

FIG. 4 shows a graph representing a spectral reflectance distribution in a visible range and an adjacent range, in Example 8 and Comparative examples 1 to 3.

FIG. 5 is a CIE chromaticity diagram in which chromaticity is plotted, for Examples 1 to 7.

FIG. 6 is a CIE chromaticity diagram in which chromaticity is plotted, for Example 8 and Comparative examples 1 to 3.

### DETAILED DESCRIPTION OF THE INVENTION

An exemplary embodiment of the present invention will be described below.

The present invention is not limited to the following embodiment.

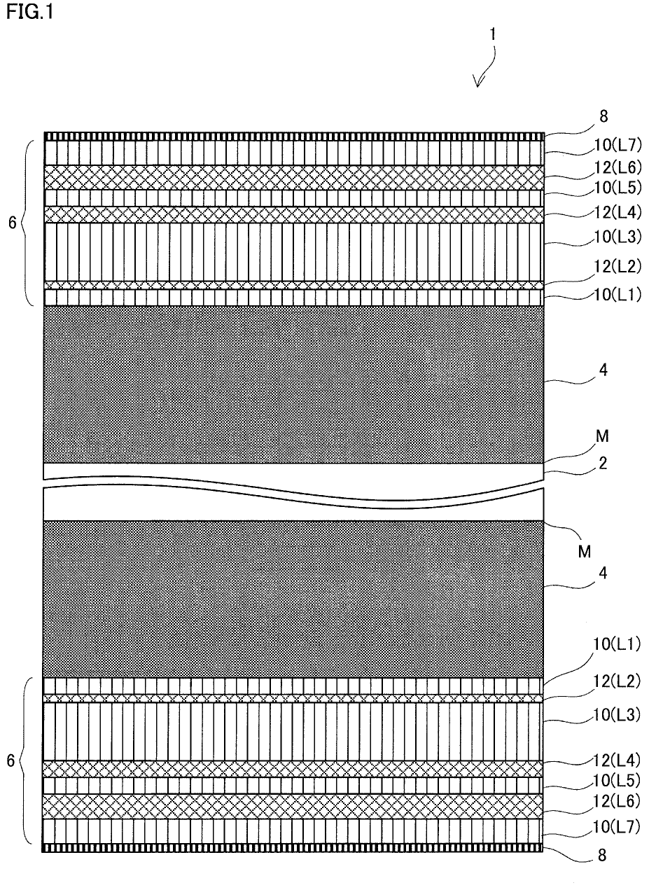

As shown in FIG. 1, a plastic optical product 1 according to the present invention has a plate-shaped base 2, optical multilayer films 6 formed on both surfaces, namely, each film-formation surface M of the base 2 via intermediate films 4, and a surface layer film 8 formed on each of the optical multilayer films 6, namely, an opposite side of the base 2. In other words, the surface layer film 8 is formed on an air side of each optical multilayer film 6.

The intermediate films 4 have the same structure, the optical multilayer films 6 have the same structure, and the surface layer films 8 have the same structure, as viewed from the base 2.

The base 2 may have a shape such as a block-like shape other than the plate-like shape. Each film-formation surface M may be a flat surface or a curved surface, and one film-formation surface M may have a shape different from that of the other film-formation surface M. At least one of the intermediate films 4 and the surface layer films 8 may be omitted. Furthermore, at least any one of the intermediate films 4, the optical multilayer films 6, and the surface layer films 8 may have a different structure for each film-formation surface M as viewed from the base 2. Moreover, at least any one of the intermediate film 4, the optical multilayer film 6, and the surface layer film 8 may be formed only on one surface of the base 2.

As a material of the base 2, plastic is used, and thermosetting resin is preferably used. Examples of the material of the base 2 include polyurethane resin, thiourethane resin, episulfide resin, polycarbonate resin, polyester resin, acrylic resin, polyether sulfone resin, poly(4-methylpentene-1) resin, diethylene glycol bis(allyl carbonate) resin, and a combination thereof. As a preferable material of the base 2 which has a high refractive index, for example, polyurethane resin obtained by addition-polymerization of a polyisocyanate compound with at least one of polythiol and sulfur-containing polyol may be used. Moreover, as a preferable material of the base 2 which has a high refractive index, episulfide resin obtained by addition-polymerization of an episulfide group with at least one of polythiol and sulfur-containing polyol may be used.

The base 2 preferably has an ultraviolet absorber added thereto.

Each intermediate film 4 is a film disposed between the base 2 and the optical multilayer film 6, and is, for example, a hard coating film. At least one of the intermediate films 4 may be a film other than a hard coating film, instead of the hard coating film, or a film other than a hard coating film may be additionally disposed on at least one of the base 2 side and the air side of the hard coating film.

The hard coating film is preferably formed by uniformly applying a hard coating solution on the surface of the base 2.

As a material of the hard coating film, an organosiloxane-based resin containing inorganic oxide particles may be preferably used. In this case, the hard coating solution is preferably prepared by mixing a solute including an organosiloxane-based resin and an inorganic oxide particle sol as main components, in water or an alcohol-based solvent. The organosiloxane-based resin is preferably obtained by hydrolyzing and condensing alkoxysilane. Specific examples of the organosiloxane-based resin include γ-glycidoxypropyltrimethoxysilane, γ-glycidoxypropyltriethoxysilane, methyl trimethoxysilane, ethyl silicate, and a combination thereof. The hydrolysis condensates of these alkoxysilanes are manufactured by hydrolyzing the alkoxysilane compounds or combinations thereof by an acidic aqueous solution such as hydrochloric acid.

Meanwhile, specific examples of a material of the inorganic oxide particles include a sol of each of zinc oxide, silicon dioxide (silica particulates), aluminium oxide, titanium oxide (titania particulates), zirconium oxide (zirconia particulates), tin oxide, beryllium oxide, antimony oxide, tungsten oxide, and cerium oxide, and mixed crystals of two or more of the sols. The diameter of the inorganic oxide particle is preferably not less than 1 nm and not greater than 100 nm, and more preferably not less than 1 nm and not greater than 50 nm from the viewpoint of assuring transparency of the hard coating film. A concentration of the inorganic oxide particles is preferably not less than 40 wt % and not greater than 60 wt % with respect to all the components in the hard coating film, from the viewpoint of assuring an appropriate level of at least one of hardness and toughness of the hard coating film. In addition, the hard coating solution may have, for example, at least one of an acetylacetone metal salt and an ethylenediaminetetraacetic acid metal salt added thereto as a curing catalyst. Furthermore, the hard coating solution may have a surfactant, a colorant, a solvent, or the like added thereto according to, for example, at least one of necessity for assuring adherence to the base 2 and necessity for facilitating formation.

A physical film thickness of the hard coating film is preferably not less than 0.5 μm and not greater than 4.0 μm, and more preferably not less than 1.0 μm and not greater than 3.0 μm. The lower limit in the film thickness range is determined since it is difficult to obtain a sufficient hardness if the film thickness is less than the lower limit. Meanwhile, the upper limit is determined since a possibility of causing a problem with physical properties such as generation of crack or fragility is significantly increased if the film thickness is greater than the upper limit.

Furthermore, as the intermediate film 4, a primer film may be additionally disposed between the hard coating film and the surface of the base 2 from the viewpoint of enhancing adherence of the hard coating film. Examples of a material of the primer film include polyurethane-based resin, acrylic resin, methacrylic resin, organosilicon-based resin, and a combination thereof. The primer film is preferably formed by uniformly applying a primer solution to the surface of the base 2. The primer solution is preferably a solution in which the above-described resin material and inorganic oxide particles are mixed in water or an alcohol-based solvent.

Each optical multilayer film 6 of the plastic optical product 1 is formed on the intermediate film 4. In a case where the intermediate film 4 is omitted, the optical multilayer film 6 is formed on each film-formation surface M of the base 2.

Each optical multilayer film 6 is formed so as to exhibit an optical function, and is, for example, an antireflection film, a mirror film, a half mirror film, an ND filter, or a band pass filter. The optical multilayer films 6 may have different functions from each other.

Each optical multilayer film 6 is formed by, for example, vacuum deposition or sputtering. The methods for manufacturing of each the optical multilayer films 6 are preferably the same from the viewpoint of assuring ease of manufacturing. The methods for manufacturing of each the optical multilayer films 6 may be different from each other.

Each optical multilayer film 6 is formed by alternately stacking low refractive index layers formed of a low refractive index material that is a metal oxide, and high refractive index layers formed of a high refractive index material that is a metal oxide.

In the plastic optical product 1, each optical multilayer film 6 is structured to have seven layers in total. Furthermore, in each optical multilayer film 6, when the layer closest to the base 2 side, namely, the layer closest to the base 2 is a first layer L1, odd layers are low refractive index layers and even layers are high refractive index layers.

The low refractive index material is silicon oxide (SiO₂). Therefore, the odd layers of each optical multilayer film 6 are each an SiO₂ layer 10. The low refractive index material may be calcium fluoride (CaF₂), magnesium fluoride (MgF₂), or a mixture which contains two or more of them and SiO₂.

The high refractive index material is zirconium oxide (ZrO₂). Therefore, the even layers of each optical multilayer film 6 are each a ZrO₂ layer 12. The high refractive index material may be titanium oxide (TiO₂), tantalum oxide (Ta₂O₅), niobium oxide (Nb₂O₅), hafnium oxide (HfO₂), selenium oxide (CeO₂), aluminium oxide (Al₂O₃), yttrium oxide (YO₂), or a mixture which contains two or more of them and ZrO₂.

In each optical multilayer film 6, one kind of the high refractive index material and one kind of the low refractive index material are used, so that the film designing is facilitated and cost for forming the films is low.

The various layers in each optical multilayer film 6 have the following various characteristics as appropriate.

That is, the SiO₂ layer 10 as a third layer L3 counting from the base 2 (the same counting manner is applies to the following description) in each optical multilayer film 6 has a physical film thickness of not less than 210 nm and not greater than 270 nm such that reflected light is made inconspicuous.

The ZrO₂ layer 12 as a second layer L2 has a physical film thickness of not less than 7 nm and not greater than 12 nm. In a case where the physical film thickness is less than 7 nm, the physical film thickness is excessively small, and it is difficult to assure accuracy of the film thickness. In a case where the physical film thickness is greater than 12 nm, it is difficult to assure inconspicuous reflected light.

Moreover, the ZrO₂ layer 12 as a fourth layer L4 has a physical film thickness of not less than 22 nm and not greater than 41 nm such that reflected light is made inconspicuous.

Furthermore, the SiO₂ layer 10 as the first layer L1 has a physical film thickness of not less than 20 nm and not greater than 50 nm. In a case where the physical film thickness is less than 20 nm, the physical film thickness is excessively small, and it is difficult to assure accuracy of the film thickness. In a case where the physical film thickness is greater than 50 nm, it is difficult to assure adherence to a portion, in particular, the intermediate film 4 as the hard coating film in contact with the first layer L1.

In addition, the sum of a physical film thickness of the SiO₂ layer 10 as a fifth layer L5 and a physical film thickness of the ZrO₂ layer 12 as a sixth layer L6 is not less than 74 nm and not greater than 80 nm such that reflected light is made more inconspicuous.

In a case where, regarding each film-formation surface M on which the optical multilayer film 6 is directly or indirectly formed, luminous reflectance on one surface is not greater than 0.8% with a D65 light source and a viewing angle of 2°, the plastic optical product 1 in which unconventionally low luminous reflectance makes reflected light extremely inconspicuous, is provided.

The color of the reflected light is preferably white (achromatic color) or bluish white, and particularly preferably white (achromatic color) from the viewpoint of making the reflected light more inconspicuous. The color of the reflected light can be qualitatively obtained as xy coordinates (x, y) in an xy color system. The xy coordinates (x, y) are represented in a CIE chromaticity diagram.

Each surface layer film 8 is a film disposed closer to the air side than the optical multilayer film 6 is. The surface layer film 8 is, for example, an antifouling film such as water repellent film, oil repellent film. In this case, an antifouling function is further imparted to the plastic optical product 1. At least one of the surface layer film 8 may be a film other than an antifouling film instead of the antifouling film, or a film such as a scratch-resistant film other than an antifouling film may be additionally disposed on at least one of the base 2 side and the air side of the antifouling film.

The antifouling film is obtained by, for example, polycondensation of an organosilicon compound. Through the polycondensation, the film can have an increased thickness and can be made dense in film coating, adherence to the optical multilayer film 6 and the surface hardness are enhanced, oil repellency in addition to water repellency is exhibited, and a coating film having excellent contamination wiping properties can be easily obtained.

The antifouling film is formed by, for example, publicly known vapor deposition or ion sputtering.

Before polycondensation, the organosilicon compound is preferably a compound having a silicon-containing functional group represented by —SiR_{y}X_{3-y}. R represents a monovalent organic group, X represents a hydrolyzable group, and y represents an integer from 0 to 2. Further, X represents, for example, an alkoxy group such as —OCH₃ and —OCH₂CH₃, an acyloxy group such as —OCOCH₃, a ketoxime group such as —ON═CRₐR_{b}, a halogen group such as —Cl and —Br, or an amino group such as —NR_{c}R_{d}. Rₐ, R_{b}, R_{c} and R_{d} each represent a monovalent organic group.

As such an organosilicon compound, a fluorine-containing organosilicon compound is preferable. A fluorine-containing organosilicon compound comprehensively has excellent water/oil repellency, electrical insulation properties, demoldability, solvent resistance, lubricity, heat resistance, and defoaming properties. Particularly, a relatively large organosilicon compound having a perfluoroalkyl group or a perfluoropolyether group in a molecule and having a molecular weight of about 1000 to 50000 has excellent antifouling properties.

By using the above-described plastic optical product 1 as a plastic spectacle lens, a spectacle that makes reflected light inconspicuous and has excellent outer appearance is produced.

Next, Examples 1 to 8 of the present invention and Comparative examples 1 to 3 that do not belong to the present invention will be described with appropriate reference to the drawings. The present invention is not limited to the following examples. According to the interpretation of the present invention, the examples may be construed as the comparative examples or the comparative examples may be construed as the examples.

In the examples and the comparative examples, the bases 2 were each made of thermosetting resin for spectacles, and had a round shape having a standard size as a plastic spectacle lens.

The bases 2 were the same among the examples and the comparative examples, and were each a spherical lens having the lens center thickness of 1.9 mm and the power of S-0.00 and were made of thiourethane resin in which the refractive index was 1.60. The base 2 itself was colorless and transparent.

In the examples and the comparative examples, hard coating films were formed as the intermediate films 4 on both surfaces by applying a hard coating solution.

The hard coating solution was applied to the base 2 and heated, whereby the hard coating film was formed so as to be in contact with the base 2 as follows.

That is, 206 g of methanol, 300 g of methanol-dispersed titania-based sol (produced by JGC Catalysts and Chemicals Ltd., solid content of 30%), 60 g of γ-glycidoxypropyltrimethoxysilane, 30 g of γ-glycidoxypropylmethyldiethoxysilane, and 60 g of tetraethoxysilane were firstly dropped into a reaction vessel, and 0.01 N (normality) of hydrochloric acid aqueous solution was dropped into the mixture, and the obtained mixture was stirred and hydrolyzed.

Subsequently, 0.5 g of a flow regulating agent and 1.0 g of a catalyst were added, and the obtained mixture was stirred at room temperature for three hours, thereby forming the hard coating solution.

The hard coating solution was applied to both surfaces of the base 2, and heated at 120° C. for 1.5 hours and hardened, thereby forming the hard coating film having a film thickness of 2.5 μm.

Furthermore, in each of Examples 1 to 8 and Comparative examples 1 to 3, the optical multilayer films 6 and the surface layer films 8 were formed on the hard coating layers on both surfaces so as to form the same structure on both the surfaces.

The optical multilayer film 6 was an antireflection film and had seven layers in total, and was firstly formed on a convex surface side, namely, front surface side of the optical product, and was subsequently formed on a concave surface side, namely, rear surface side of the optical product, by vacuum deposition.

The SiO₂ layer 10 to be disposed at an odd layer in the optical multilayer film 6 was formed in a vacuum chamber by normal deposition by using SiO₂ available from Canon Optron, Inc. as a vapor deposition source.

The ZrO₂ layer 12 to be disposed at an even layer in the optical multilayer film 6 was formed in a vacuum chamber by ion assisted deposition by using ZrO₂ available from Canon Optron, Inc. as a vapor deposition source. Ion-assist gas in the ion-assist was mixed gas of oxygen (O₂) gas and argon (Ar) gas as rare gas, and output in the ion-assist was performed at an acceleration voltage of 500 V and an acceleration current of 300 mA. The refractive index of each ZrO₂ layer 12 was greater than the refractive index of SiO₂, and was able to be adjusted by several factors, for example, a film forming rate, a vacuum chamber temperature as a film formation temperature, the degree of vacuum, presence or absence of ion-assist, an acceleration voltage value in the ion-assist, and a kind of gas.

The surface layer film 8 was a water/oil repellent film as an antifouling film, and was formed on the optical multilayer film 6 at a thickness of 5.00 nm by using OF—SR available from Canon Optron, Inc.

In Examples 1 to 8 and Comparative examples 1 to 3, the first layer L1 to the seventh layer L7 of the optical multilayer film 6, and the surface layer film 8 were formed as indicated in the upper portion of each of the following Table 1 to Table 3. Each refractive index was a refractive index at a wavelength of 500 nm in each layer. According to Examples 1 to 8 and Comparative examples 1 to 3, the refractive index among all the SiO₂ layers 10 was 1.469, which is same value. The refractive index among all the ZrO₂ layers 12 was 2.106, which is same value. The refractive index among all the surface layer film 8 was 1.350, which is same value.

TABLE 1

| | | Refractive index | Physical film thickness [nm] | | | |
|---|---|---|---|---|---|---|
| | Material | at 500 nm | Example 1 | Example 2 | Example 3 | Example 4 |
| First | SiO₂ | 1.469 | 35.00 | 20.50 | 24.00 | 30.50 |
| layer L1 | | | | | | |
| Second | ZrO₂ | 2.106 | 10.00 | 8.80 | 11.00 | 12.00 |
| layer L2 | | | | | | |
| Third | SiO₂ | 1.469 | 228.00 | 210.00 | 220.00 | 224.50 |
| layer L3 | | | | | | |
| Fourth | ZrO₂ | 2.106 | 32.00 | 35.00 | 41.00 | 40.50 |
| layer L4 | | | | | | |
| Fifth | SiO₂ | 1.469 | 27.00 | 18.00 | 15.50 | 16.50 |
| layer L5 | | | | | | |
| Sixth | ZrO₂ | 2.106 | 51.00 | 60.00 | 59.00 | 58.00 |
| layer L6 | | | | | | |
| Seventh | SiO₂ | 1.469 | 100.00 | 98.00 | 89.00 | 89.50 |
| layer L7 | | | | | | |

| Water/oil repellent agent | 1.350 | 5.00 | 5.00 | 5.00 | 5.00 |
|---|---|---|---|---|---|
| Physical film thickness of fifth layer + | | 78.00 | 78.00 | 74.50 | 74.50 |
| physical film thickness of sixth layer [nm] | | | | | |
| Chromaticity | x | 0.24 | 0.23 | 0.24 | 0.24 |
| | y | 0.26 | 0.28 | 0.27 | 0.25 |
| Luminous reflectance | D65 light source, | 0.52 | 0.55 | 0.65 | 0.63 |
| (%) | viewing angle | | | | |
| | of 2° | | | | |

TABLE 2

| | | Refractive | | | |
|---|---|---|---|---|---|
| | | index at | Physical film thickness [nm] | | |
| | Material | 500 nm | Example 5 | Example 6 | Example 7 |
| First | SiO₂ | 1.469 | 48.00 | 48.00 | 50.00 |
| layer L1 | | | | | |
| Second | ZrO₂ | 2.106 | 7.00 | 7.00 | 7.80 |
| layer L2 | | | | | |
| Third | SiO₂ | 1.469 | 258.50 | 260.00 | 238.50 |
| layer L3 | | | | | |
| Fourth | ZrO₂ | 2.106 | 22.00 | 22.50 | 30.50 |
| layer L4 | | | | | |
| Fifth | SiO₂ | 1.469 | 44.00 | 43.50 | 26.50 |
| layer L5 | | | | | |
| Sixth | ZrO₂ | 2.106 | 35.00 | 35.00 | 52.00 |
| layer L6 | | | | | |
| Seventh | SiO₂ | 1.469 | 107.50 | 107.50 | 99.00 |
| layer L7 | | | | | |

| Water/oil repellent agent | 1.350 | 5.00 | 5.00 | 5.00 |
|---|---|---|---|---|
| Physical film thickness of fifth | | 79.00 | 78.50 | 78.50 |
| layer + physical film thickness | | | | |
| of sixth layer [nm] | | | | |
| Chromaticity | x | 0.24 | 0.24 | 0.22 |
| | y | 0.27 | 0.28 | 0.26 |
| Luminous | D65 light | 0.65 | 0.70 | 0.53 |
| reflectance (%) | source, | | | |
| | viewing | | | |
| | angle of | | | |
| | 2° | | | |

TABLE 3

| | | | Physical film thickness [nm] | | | |
|---|---|---|---|---|---|---|
| | | Refractive index | Comparative | Comparative | Comparative | |
| | Material | at 500 nm | example 1 | example 2 | example 3 | Example 8 |
| First | SiO₂ | 1.469 | 20.00 | 31.50 | 55.00 | 24.50 |
| layer L1 | | | | | | |
| Second | ZrO₂ | 2.106 | 6.00 | 14.00 | 6.20 | 10.50 |
| layer L2 | | | | | | |
| Third | SiO₂ | 1.469 | 200.00 | 226.00 | 280.00 | 220.00 |
| layer L3 | | | | | | |
| Fourth | ZrO₂ | 2.106 | 30.00 | 41.50 | 21.00 | 43.50 |
| layer L4 | | | | | | |
| Fifth | SiO₂ | 1.469 | 11.50 | 15.00 | 49.50 | 14.50 |
| layer L5 | | | | | | |
| Sixth | ZrO₂ | 2.106 | 81.50 | 65.50 | 31.00 | 58.00 |
| layer L6 | | | | | | |
| Seventh | SiO₂ | 1.469 | 88.50 | 90.00 | 106.50 | 90.00 |
| layer L7 | | | | | | |

| Water/oil repellent agent | 1.350 | 5.00 | 5.00 | 5.00 | 5.00 |
|---|---|---|---|---|---|
| Physical film thickness of fifth layer + | | 93.00 | 80.50 | 80.50 | 72.50 |
| physical film thickness of sixth layer [nm] | | | | | |
| Chromaticity | x | 0.25 | 0.30 | 0.29 | 0.24 |
| | y | 0.38 | 0.26 | 0.33 | 0.30 |
| Luminous reflectance | D65 light source, | 0.55 | 0.63 | 0.91 | 0.83 |
| (%) | viewing angle | | | | |
| | of 2° | | | | |

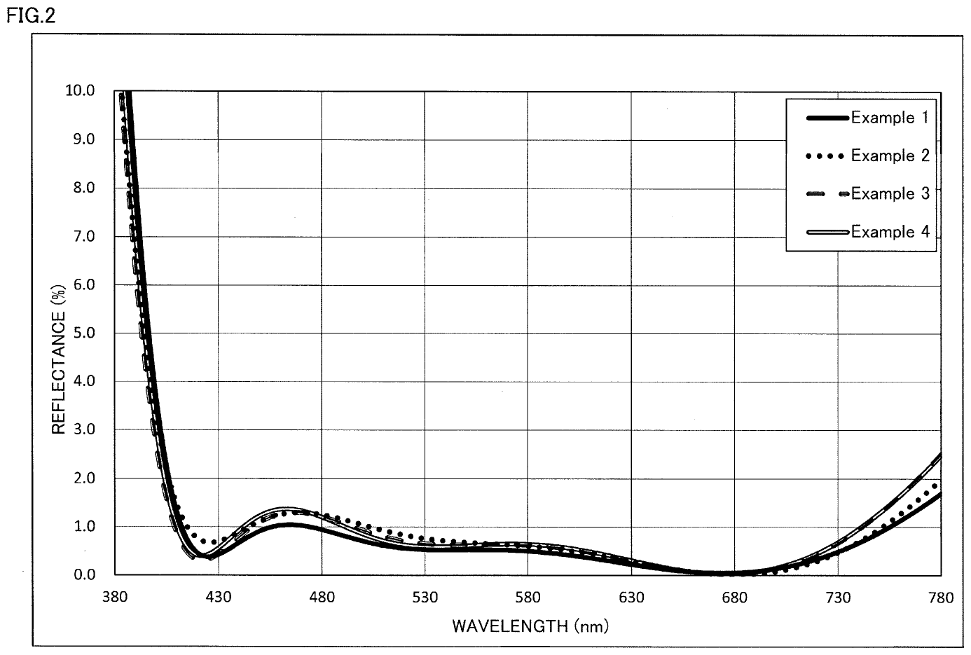

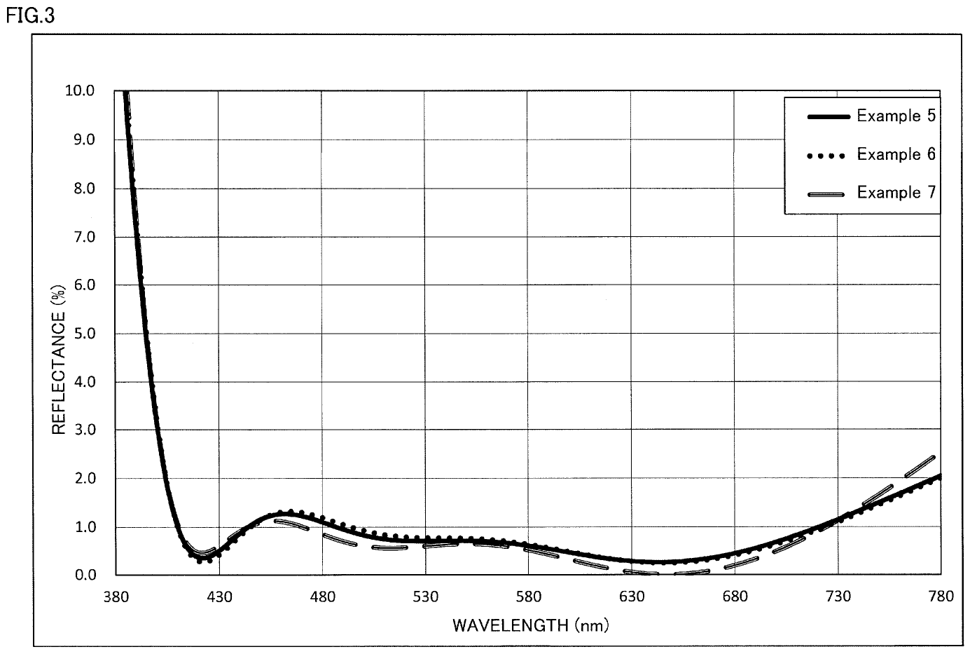

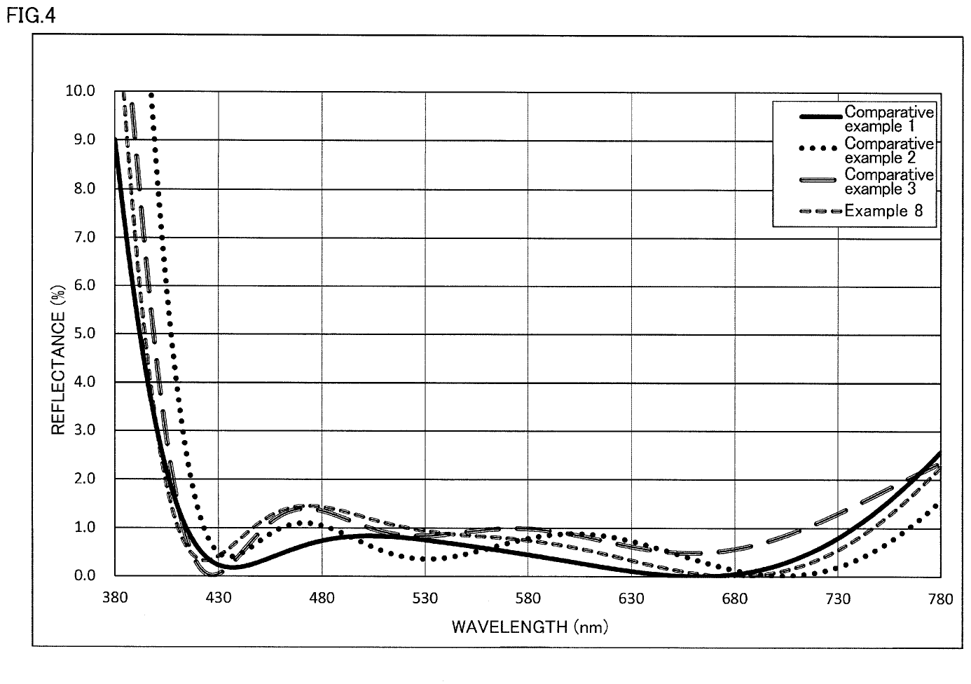

For Examples 1 to 8 and Comparative examples 1 to 3, as shown in FIG. 2 to FIG. 4, a spectral reflectance distribution in a visible range and an adjacent range were measured. In the description, the visible range is a range of wavelengths of not less than 400 nm and not greater than 780 nm, and the adjacent range is a range of wavelengths of not less than 380 nm and not greater than 400 nm. Further, as shown in the lower side of the lower portion in each of Table 1 to Table 3, luminous reflectance at the convex surface side with a D65 light source and a viewing angle of 2° were measured.

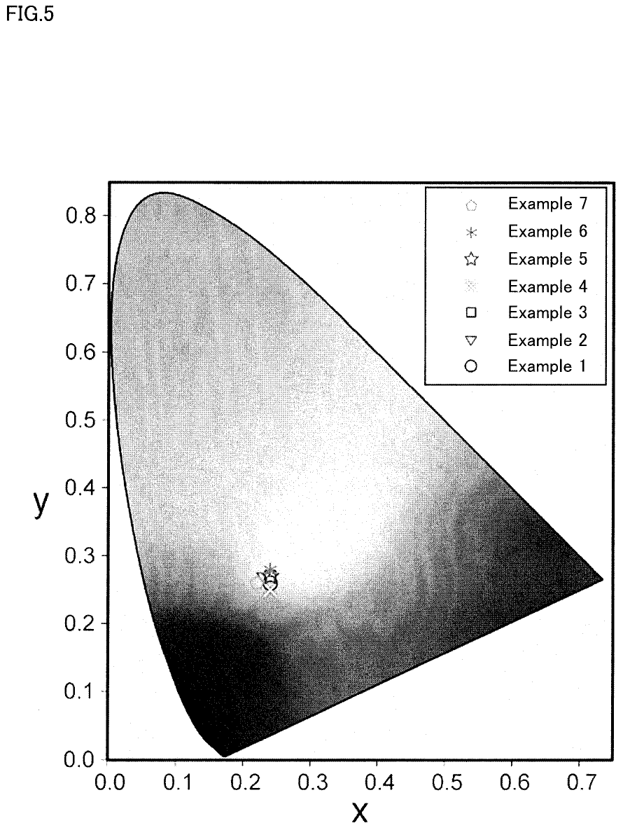

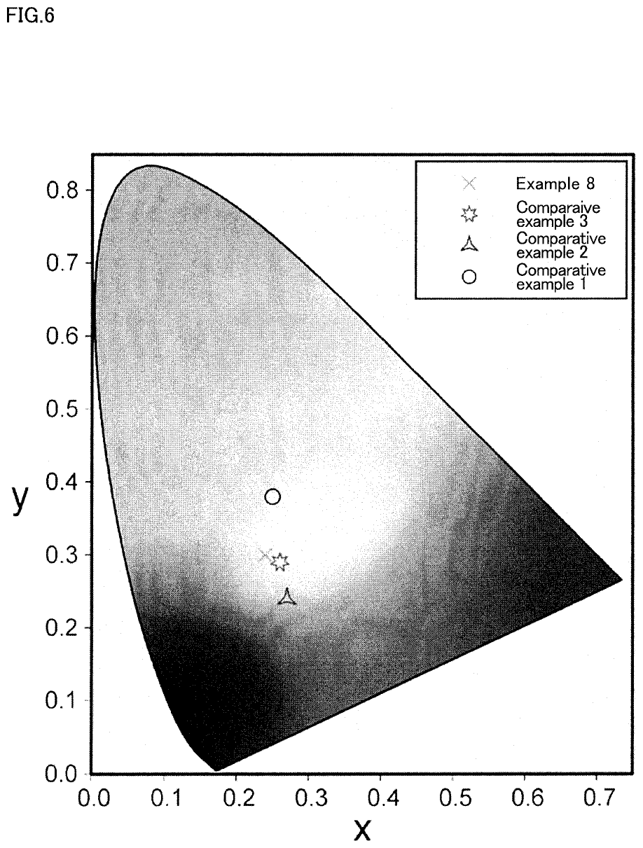

As shown in the upper side of the low portion in each of Table 1 to Table 3, for Examples 1 to 8 and Comparative examples 1 to 3, chromaticity, namely, x and y in an xy color system with a D65 light source and viewing angle of 2° was measured. FIG. 5 and FIG. 6 are each a CIE chromaticity diagram in which x and y in Examples 1 to 8 and Comparative examples 1 to 3 are plotted.

In comparative example 1, the physical film thickness of the third layer L3 was 200.00 nm, and was less than 210 nm, the physical film thickness of the second layer L2 was 6.00 nm, and was less than 7 nm, and total of the physical film thickness of the fifth layer L5 and the sixth layer L6 was 93.00 nm, and was greater than 80 nm. In Comparative example 1, the luminous reflectance was 0.55% and was not greater than 0.8%, and was thus very good. However, in Comparative example 1, the chromaticity (x, y)=(0.25, 0.38) was satisfied, and reflected light generated by slight reflection had a green color and was conspicuous in chromaticity. The spectral reflectance distribution in Comparative example 1 formed a W shape having the center maximum value at about 500 nm.

In Comparative example 2, the physical film thickness of the third layer L3 was 226.00 nm, and was in a range of not less than 210 nm and not greater than 270 nm, the physical film thickness of the second layer L2 was 14.00 nm, and was greater than 12 nm, the physical film thickness of the fourth layer L4 was 41.50 nm, and was greater than 41 nm, and total of the physical film thickness of the fifth layer L5 and the sixth layer L6 was 80.50 nm, was greater than 80 nm. In Comparative example 2, the luminous reflectance was 0.63% and was not greater than 0.8%, and was thus very good. However, in Comparative example 2, the chromaticity (x, y)=(0.30, 0.26) was satisfied, and reflected light generated by slight reflection had a pink color and was conspicuous in chromaticity. In Comparative example 2, the spectral reflectance distribution formed a WW shape having two local maximum values of about 1.0% at about 475 nm and about 610 nm.

In Comparative example 3, the physical film thickness of the third layer L3 was 280.00 nm, and was greater than 270 nm, the physical film thickness of the second layer L2 was 6.20 nm, and was less than 7 nm, the physical film thickness of the fourth layer L4 was 21.00 nm, and was less than 22 nm, and total of the physical film thickness of the fifth layer L5 and the sixth layer L6 was 80.50 nm, and was greater than 80 nm. In Comparative example 3, the chromaticity (x, y)=(0.29, 0.33) was satisfied, and reflected light generated by slight reflection had a white color (achromatic color) and was inconspicuous in chromaticity. However, in Comparative example 3, the luminous reflectance was 0.91%, was greater than 0.8% by an amount greater than 0.1 points, and did not reach an excellent level. In Comparative example 3, the spectral reflectance distribution formed a WW shape having the local maximum values at about 475 nm and about 580 nm. In Comparative example 3, the physical film thickness of the first layer L1 was 55.00 nm, and was greater than 50 nm, and adherence of the optical multilayer film 6 to the hard coating film was not sufficiently assured.

In Example 8, the physical film thickness of the third layer L3 was 220.00 nm, and was in a range of not less than 210 nm and not greater than 270 nm, the physical film thickness of the second layer L2 was 10.50 nm, and was in a range of not less than 7 nm and not greater than 12 nm, the physical film thickness of the fourth layer L4 was 43.50 nm, and was slightly greater than 41 nm, and total of the physical film thickness of the fifth layer L5 and the sixth layer L6 was 72.50 nm, and was less than 74 nm. In Example 8, the chromaticity (x, y)=(0.24, 0.30) was satisfied, and the reflected light generated by slight reflection had a white color (achromatic color) and was inconspicuous in chromaticity. In Example 8, although the luminous reflectance was 0.83%, was slightly, namely, 0.03 points greater than 0.8%, and was slightly inferior to those of Examples 1 to 7, excellent luminous reflectance was assured. In Example 8, the spectral reflectance distribution formed a W shape having the local maximum value at about 475 nm.

Meanwhile, in each of Examples 1 to 7, the physical film thickness of the third layer L3 was in a range of not less than 210 nm and not greater than 270 nm, the physical film thickness of the second layer L2 was in a range of not less than 7 nm and not greater than 12 nm, and the physical film thickness of the fourth layer L4 was in a range of not less than 22 nm and not greater than 41 nm. Total of the physical film thickness of the fifth layer L5 and the sixth layer L6 was in a range of not less than 74 nm and not greater than 80 nm. Therefore, in Examples 1 to 7, the optical multilayer film 6 had antireflection performance, and each luminous reflectance was not greater than 0.8% and was thus at an extremely excellent level. Each chromaticity of reflected light generated by slight reflection indicated a white color (achromatic color) or a bluish white color, and the reflected light was viewed by a person so as to be colorless and transparent or so as to have a very light blue color, and was inconspicuous. Each reflectance distribution formed a W shape having the local maximum value in a range of not less than 450 nm and not greater than 475 nm.

Furthermore, in each of Examples 1 to 7, the physical film thickness of the first layer L1 was in a range of not less than 20 nm and not greater than 50 nm. Therefore, the first layer L1 was easily formed, and adherence to the hard coating film was sufficiently assured.

Examples 1 to 8 are each a plastic spectacle lens in which the optical multilayer films 6 are formed, via the intermediate films 4 that are the hard coating films, on both surfaces of the base 2 made of plastic. In each optical multilayer film 6, the SiO₂ layers 10 made of SiO₂ and the ZrO₂ layers 12 made of ZrO₂ alternate such that the total number of the SiO₂ layers 10 and the ZrO₂ layers 12 is seven and the first layer L1 closest to the base 2 is the SiO₂ layer 10. In Examples 1 to 8, the physical film thickness of the SiO₂ layer 10 disposed at the third layer L3 counting from the base 2 is not less than 210 nm and not greater than 270 nm, and the physical film thickness of the ZrO₂ layer 12 disposed at the second layer counting from the base 2 is not less than 7 nm and not greater than 12 nm. Therefore, reflected light becomes inconspicuous. In Examples 1 to 7, the physical film thickness of the ZrO₂ layer 12 disposed at the fourth layer L4 counting from the base 2 is not less than 22 nm and not greater than 41 nm. Therefore, reflected light becomes more inconspicuous.

In Examples 1 to 8, the physical film thickness of the SiO₂ layer 10 as the first layer L1 closest to the base 2 is not less than 20 nm and not greater than 50 nm. Therefore, the optical multilayer film 6 is more easily formed, and assuredly has excellent adherence to the intermediate film 4.

In addition, in Examples 1 to 7, the sum of the physical film thickness of the SiO₂ layer 10 disposed at the fifth layer L5 counting from the base 2 and the physical film thickness of the ZrO₂ layer 12 disposed at the sixth layer L6 counting from the base 2 is not less than 74 nm and not greater than 80 nm. Therefore, reflected light becomes more inconspicuous.

The intermediate film 4 is a hard coating film. Therefore, the hardness of the plastic optical product 1 is preferable, and, consequently, durability thereof is preferable.

In Examples 1 to 7, the luminous reflectance at the convex surface at which the optical multilayer film 6 is formed, is not greater than 0.8%. Therefore, the luminous reflectance is extremely low, and the reflected light further becomes more inconspicuous.

Furthermore, in Examples 1 to 8, reflected light at the surface at which the optical multilayer film 6 is formed has a white color or a bluish white color. Therefore, the reflected light further becomes more inconspicuous.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A plastic optical product comprising
an optical multilayer film formed directly or via an intermediate film on at least one surface of a plastic base, wherein
in the optical multilayer film, SiO₂ layers made of SiO₂ and ZrO₂ layers made of ZrO₂ alternate such that a total number of the SiO₂ layers and the ZrO₂ layers is seven and a layer closest to the base is the SiO₂ layer,
the SiO₂ layer disposed at a third layer counting from the base has a physical film thickness of not less than 210 nm and not greater than 270 nm, and
the ZrO₂ layer disposed at a second layer counting from the base has a physical film thickness of not less than 7 nm and not greater than 12 nm.

2. The plastic optical product according to claim 1, wherein the ZrO₂ layer disposed at a fourth layer counting from the base has a physical film thickness of not less than 22 nm and not greater than 41 nm.

3. The plastic optical product according to claim 1, wherein the SiO₂ layer that is a layer closest to the base has a physical film thickness of not less than 20 nm and not greater than 50 nm.

4. The plastic optical product according to claim 1, wherein a sum of a physical film thickness of the SiO₂ layer disposed at a fifth layer counting from the base and a physical film thickness of the ZrO₂ layer disposed at a sixth layer counting from the base is not less than 74 nm and not greater than 80 nm.

5. The plastic optical product according to claim 1, wherein the intermediate film is a hard coating film.

6. The plastic optical product according to claim 1, wherein luminous reflectance at a surface at which the optical multilayer film is formed is not greater than 0.8%.

7. The plastic optical product according to claim 1, wherein reflected light at a surface at which the optical multilayer film is formed has a white color or a bluish white color.

8. A plastic spectacle lens comprising the plastic optical product according to claim 1.
